(19) United States
(12) Patent Application Publication
(10) Pub. No.: US 2026/0138873 A1
(43) Pub. Date: May 21, 2026

(54) CATALYST SYSTEM HAVING A CATALYST NETWORK COMPRISING A NOBLE METAL WIRE FOR LONG CAMPAIGNS IN AMMONIA OXIDATION

(71) Applicant: HERAEUS PRECIOUS METALS GMBH & CO. KG, Hanau (DE)

(72) Inventors: Jens HESSE, Hanau (DE); Dirk MAIER, Hanau (DE); Pascal HIRSCHEL, Hanau (DE); Uwe JANTSCH, Hanau (DE)

(21) Appl. No.: 19/113,762

(22) PCT Filed: Jun. 27, 2023
(86) PCT No.: PCT/EP2023/067396

§ 371 Date: Mar. 20, 2025

(30) Foreign Application Priority Data
Sep. 30, 2022 (EP) 22199163.1

(51) Int. Cl. C01B 21/26; B01J 23/44; B01J 23/46; B01J 35/64

(52) U.S. Cl. CPC C01B 21/265; B01J 23/44; B01J 23/464; B01J 35/643; B01J 2231/70

(57) ABSTRACT

The present invention relates to a catalyst system comprising more than one catalyst network, wherein at least one of the catalyst networks contains at least one noble metal wire consisting of a binary PtRh alloy. The binary PtRh alloy consists of 3.4-4.6 wt. % of rhodium, impurities and the remainder platinum. The catalyst system does not comprise a catalyst network containing a noble metal wire made of a further binary PtRh alloy comprising more than 7 wt. % of rhodium. The invention also relates to a method for the catalytic oxidation of ammonia, in which a catalyst system according to the invention is used.

The present invention relates to a catalyst system comprising more than one catalyst network, wherein at least one of the catalyst networks contains at least one noble metal wire consisting of a binary PtRh alloy. The binary PtRh alloy consists of 3.4-4.6 wt. % of rhodium, impurities and the remainder platinum. The catalyst system does not comprise a catalyst network containing a noble metal wire made of a further binary PtRh alloy comprising more than 7 wt. % of rhodium. The invention also relates to a method for the catalytic oxidation of ammonia, in which a catalyst system according to the invention is used.

Catalyst systems having catalyst networks are used in particular in flow reactors for gas reactions. They are used, for example, in the preparation of hydrocyanic acid by the Andrussow process or in the preparation of nitric acid by the Ostwald process. Suitable catalysts must provide a large catalytically active surface. In general, therefore, catalyst networks in the form of three-dimensional, gas-permeable structures of noble metal wires are used. Collecting systems for recovering evaporated catalytically active components are also frequently based on such lattice structures. Usually, a plurality of networks are expediently arranged one behind the other and combined to form a catalyst system. The catalyst systems consist of 2 to 50 catalyst networks lying one above the other, wherein this number essentially depends on the conditions in the reactor, for example the operating pressure and the mass flow rate of the gases. The diameter of the networks reaches up to 6 m in certain burners.

The catalyst networks usually consist of single-layer or multi-layer networks in the form of knitted fabrics and/or woven fabrics. The individual networks are made of fine noble metal wires that predominantly contain platinum (Pt), palladium (Pd), rhodium (Rh) or alloys of these metals. The choice of material of the noble metal wire is determined, inter alia, by the position and function of the catalyst network in the catalyst system. In particular, catchment networks may also contain further constituents, for example nickel, in addition to noble metals. The use of noble metals is expensive and is kept as low as possible. On the other hand, the “catalytic efficiency,” which is an important parameter and a measure of the conversion of the reactants and thus of the yield, generally increases as the noble metal content rises up to a maximum.

The use of binary PtRh alloys in the catalytic oxidation of ammonia with a rhodium content of 2 to 50 wt. % (percent by weight) is known, for example from U.S. Pat. No. 1,706,055 A.

For a planned campaign, operators of ammonia oxidation systems define the amount of ammonia that they provide as a function of a minimum amount of nitrogen monoxide that is to be produced. It has become established in the industry that the design of a network catalyst for ammonia oxidation is based on the reference variable of catalytic efficiency, which is understood as the amount of ammonia used per day and per square meter of cross-sectional area of the reactor. Usually, only the initial efficiency of a catalyst is taken into account when designing a catalyst system. As a result of oxidation and sublimation, the catalyst networks lose noble metal and thus efficiency during use, so that they have to be replaced after a certain service life.

The PtRh5 alloy, which has become established as an industrial standard for use in medium-pressure systems, has proven to be a suitable compromise with regard to service life, catalytic efficiency and noble metal use as described, for example, in EP 1284927 A1. Typical alloys in industry also include PtRh8 and PtRh10; in specific cases, especially at higher operating pressures, PtRh3 is also used.

To optimize catalyst efficiency, different binary PtRh alloys are frequently combined with one another. For example, EP 3680015 A1 discloses catalyst systems composed of at least two network layers, in which different binary PtRh alloys are used of which the rhodium content decreases in the flow direction. Due to a relatively high content of more than 7 wt % of rhodium in at least one of the network layers, the rhodium content of the overall system is also high overall.

However, in particular in the case of reactors that are used for a relatively long time, it has been surprisingly found that the use of a binary platinum alloy with a rhodium content between the industry standard 3 and 5 wt. % results in an unexpected increase in the overall conversion achievable by the catalyst system. The use of such alloys has also proven to be advantageous for a longer total running time and the average efficiency achievable over this running time. In this technology area, a 1 percent by weight difference in the rhodium content also makes a significant difference in the cost of the networks and catalyst systems.

The object of the invention was therefore to provide a catalyst system optimized for long campaign lengths in ammonia oxidation. In particular, it was part of the object to provide a catalyst system that allows a maximum total product yield. Another object was to provide a catalyst system that comprises a rhodium content optimized for this purpose.

The object is achieved by a catalyst system comprising more than one catalyst network, wherein at least one of the catalyst networks contains at least one noble metal wire consisting of a binary PtRh alloy, characterized in that the binary PtRh alloy of the at least one noble metal wire consists of 3.4-4.6 wt. % of rhodium, impurities and the remainder platinum, and in that the catalyst system does not comprise a catalyst network containing a noble metal wire made of a further binary PtRh alloy comprising more than 7 wt. % of rhodium.

The invention further provides a method for using such a catalyst network.

Surprisingly, it has been found that the average efficiency of a catalyst system according to the invention is unexpectedly higher than that of systems that contain the industry standard alloy PtRh3 and comparable to systems having the likewise industry standard, more rhodium-rich PtRh5. In this case, the average efficiency is understood to mean the average efficiency of the catalyst system over the possible total running time before replacement is required. Replacement becomes necessary when the catalyst system becomes unstable due to corrosion phenomena or the catalyst efficiency falls below a certain value, typically this is 94% in the pressure range from 4 to 6 bar.

The present invention relates to a catalyst system for a flow reactor. In flow reactors, catalysts in the form of gas-permeable fabrics are typically incorporated into the reaction zone in a plane perpendicular to the flow direction of the fresh gas. Such gas-permeable fabrics are usually employed in the form of catalyst networks. A catalyst system is understood to mean an assembly of such catalyst networks.

The catalyst system comprises more than one catalyst network. A catalyst network is understood to mean a single-layer or multi-layer gas-permeable fabric. The surface formation of the catalyst networks is preferably achieved by intertwining one or more noble metal wires to form a mesh. Catalyst networks can be produced, for example, by weaving or knitting a noble metal wire or a plurality of noble metal wires. The structure of the catalyst networks can be set in a targeted manner by the use of different weaving or knitting patterns and/or different mesh sizes. The catalyst networks of the catalyst system can be woven or knitted independently of one another.

In preferred embodiments, the catalyst network can comprise a three-dimensional structure. In the context of this application, networks are understood as flat, two-dimensional objects. A three-dimensional structure is understood to mean that the catalyst network also comprises, in addition to its planar, two-dimensional extension, an extension into the third spatial dimension. Catalyst networks having a three-dimensional structure comprise a larger free surface area and better material transport conditions between the gas and the surface, which advantageously affects the catalytic effectiveness and can reduce the pressure drop in the flow reactor. A three-dimensional structure can be obtained by using at least one noble metal wire having a two- or three-dimensional structure or by texturing the catalyst network. Three-dimensional structures of the catalyst network may be, for example, wave-shaped or coil-shaped. To produce such structures, an initially planar catalyst network may be subjected to a process step in which a three-dimensional structure is embossed or produced by folding.

The mass per unit area of the catalyst networks is not further restricted and can be, for example, in the range from 100 to 950 g/m², in particular in the range from 150 to 900 g/m². The mass per unit area of a catalyst network is influenced, inter alia, by the noble metal wire used or the noble metal wires used and the knitting or weaving pattern used, in particular by the relevant mesh size.

The catalyst networks each contain at least one noble metal wire. A noble metal wire is understood to be a wire consisting of noble metal or a noble metal alloy. A noble metal alloy is understood to mean an alloy that consists of noble metal to an extent of more than 50 wt. %. The fact that an alloy consists of more than 50 wt. % of noble metal means that the weight proportion of noble metal makes up at least 50 wt. % of the weight of the total alloy.

Preferably, a noble metal wire is used that has a diameter of 40 to 150 μm, preferably 50 to 130 μm, in particular 60 to 120 μm.

The noble metal wire or the noble metal wires can be designed as round wire, i.e., with a round cross section. In another embodiment, the noble metal wire or the noble metal wires can be designed as a flattened round wire or as a wire having a different cross section.

The noble metal wire or the noble metal wires can have a two- or three-dimensional structure. The noble metal wire or the noble metal wires can comprise, for example, one or more undulating, stepped or helical longitudinal portions or can be formed as an undulating, stepped or helically bent wire over its entire length. If the noble metal wire or the noble metal wires comprise a helical longitudinal portion, both the active catalyst surface of a catalyst network and the mass of the catalyst network relative to a surface unit may be adjusted via the number of windings of the helical longitudinal portions. When a noble metal wire having two or three-dimensional structure is used, a catalyst network produced therefrom has a three-dimensional structure.

The noble metal wire or the noble metal wires may comprise a plurality of wires, in this case also referred to as filaments. In such cases, the noble metal wire or the noble metal wires can have increased strength, which improves the long-term stability of the catalyst network. The filaments may be twisted together; in these cases the noble metal wire or the noble metal wires comprise a rope-like structure. It can also be advantageous if the noble metal wire or the noble metal wires comprise at least one filament that is helically wound around at least one further filament.

At least one of the catalyst networks contains at least one noble metal wire consisting of a binary PtRh alloy. A binary alloy, also referred to as a two-component alloy, is understood to mean an alloy that contains only two alloying elements in addition to impurities.

The desired optimization of the average efficiency for the longest possible maximum running time requires a comparatively narrow range of the composition of the binary PtRh alloy. The binary PtRh alloy consists of 3.4-4.6 wt. % of rhodium, impurities and the remainder platinum. The binary PtRh alloy preferably consists of 3.6-4.4 wt. % of rhodium, particularly preferably of 3.8-4.2 wt. %; for example, the binary PtRh-alloy can consist of 3.6-4.0 wt. % of rhodium.

It should be noted at this point that the statements regarding the composition of the noble metal wire or of the noble metal wires relate to the state prior to use in a reactor system. In other words, the “fresh” noble metal wire is thus referred to. During use, the composition of the noble metal wire changes as explained above, for example due to the evaporation of platinum fractions.

Impurities of the binary PtRh alloy are understood to mean customary impurities that are intended to enter the binary PtRh alloy or that have unavoidably entered the starting materials in the course of the preparation process or that could not be (completely) removed from the raw materials with reasonable effort. The proportion of impurities in total is preferably no more than 1 wt. % of the binary PtRh alloy described, preferably no more than 0.5 wt. %.

The at least one catalyst network can consist entirely of the at least one noble metal wire of the binary PtRh alloy, but it can also comprise further constituents, for example further noble metal wires or wires made of non-noble metals.

In many cases, it can be advantageous if the catalyst network comprises at least one further noble metal wire, i.e., is formed from two or more noble metal wires. The at least two noble metal wires can have the same or different diameters and/or the same or different structures.

The noble metal of the further noble metal wire is preferably selected from the group consisting of platinum metals, gold and silver and combinations thereof. Platinum metals are understood to mean the metals of the so-called platinum group, i.e., platinum (Pt), palladium (Pd), iridium (Ir), rhodium (Rh), osmium (Os) and ruthenium (Ru).

The catalyst system comprises more than one catalyst network; in other words, the catalyst system comprises at least two catalyst networks. The at least two catalyst networks can be the same or different. Depending on the intended use of the catalyst system and the reaction conditions in the flow reactor, catalyst networks having different or identical structures and different or identical noble metal wires can be combined with each other.

The catalyst system does not comprise a catalyst network containing a noble metal wire made of a further binary PtRh alloy comprising more than 7 wt. % of rhodium. Binary PtRh alloys used consist of no more than 7 wt. % of rhodium, impurities and the remainder platinum. The proportion of the impurities of the further binary PtRh alloy is preferably no more than 1 wt. %, in particular no more than 0.5 wt. %, in total.

The use of no binary PtRh alloy comprising a higher rhodium content allows a particularly cost-efficient implementation of the catalyst system and has also been shown to be advantageous in terms of average efficiency. However, the catalyst system can comprise further catalyst networks having a noble metal wire made of a binary PtRh alloy comprising less than 7 wt. % of rhodium, for example made of PtRh6.

Particularly advantageously, the catalyst system does not comprise a catalyst network containing a noble metal wire made of a further binary PtRh alloy comprising more than 6.5 wt. % of rhodium, in particular comprising no more than 6 wt. % of rhodium. It may be particularly preferred that the catalyst system does not comprise any further catalyst network containing a noble metal wire made of another binary PtRh alloy.

The catalyst system may comprise one or more catalyst network groups. A catalyst network group is understood to mean an ensemble of catalyst networks that are formed from at least one noble metal wire of the same composition. Typically, a catalyst network group comprises more than one catalyst network.

The masses per unit area of the catalyst networks within a catalyst network group can be the same or different. It has proven advantageous if the catalyst networks of a catalyst network group have the same mass per unit area. The masses per unit area of the catalyst networks of the catalyst network groups can remain equal, decrease or increase in the flow direction.

For example, the catalyst system can comprise at least three catalyst networks comprising a noble metal wire made of the binary PtRh alloy comprising 3.4-4.6 wt. % of rhodium, more preferably at least five. Preferably, at least 50% of the catalyst networks of the catalyst system are catalyst networks comprising a noble metal wire made of the binary PtRh alloy comprising 3.4-4.6 wt. % of rhodium.

Typically, a catalyst system can contain at least one catalyst network or a catalyst network group containing a noble metal wire made of a palladium alloy. This catalyst network or this catalyst network group is preferably arranged downstream in the flow direction. Catalyst networks of this kind can function as catchment networks, i.e., they can collect evaporated platinum from a catalyst network group arranged further upstream in the flow direction.

A palladium alloy is understood to mean an alloy that consists of palladium to an extent of more than 50 wt %. The palladium alloy can contain between 50 and 97 wt % of palladium, preferably more than 60 wt % of palladium, particularly preferably more than 70 wt % of palladium. The palladium alloy can be a ternary palladium alloy consisting of palladium, platinum and rhodium in addition to impurities, or a binary palladium alloy consisting of palladium and nickel, tungsten, platinum, or gold in addition to impurities. The proportion of impurities in total is no more than 1 wt % of the palladium alloy, preferably no more than 0.5 wt %. By way of example, the palladium alloy of the noble metal wire can consist of 70-97 wt % of palladium, 0-10 wt % of rhodium and 3-30 wt % of nickel, tungsten, platinum or gold, in addition to impurities. The noble metal wire can comprise, for example, a PdPt(3-30)Rh(1-10) alloy, PdNi(3-30) alloy, a PdW(3-30) alloy, a PdPt(3-30) alloy, or a PdAu(3-30) alloy. In this case, PdM(a-b) means, for example, that the alloy contains the metal M with a weight proportion in the range from a to b wt %, and the remaining proportion (100−(a to b)) of the wt %, apart from impurities, consists of palladium.

For example, the catalyst system can comprise at least three catalyst networks containing a noble metal wire made of the binary PtRh alloy comprising 3.4-4.6 wt. % of rhodium and at least one catalyst network containing a noble metal wire made of a palladium alloy. In particular, the catalyst system can comprise at least three catalyst networks containing a noble metal wire made of the binary PtRh alloy comprising 3.4-4.6 wt. % of rhodium and at least two catalyst networks containing a noble metal wire made of a palladium alloy.

The catalyst system may also comprise further components.

For example, the catalyst system can comprise an ignition layer as a first catalyst network or as a first catalyst network group. An ignition layer comprises a noble metal wire which contains only platinum and impurities.

It can be advantageous in particular that the most upstream catalyst network, as seen in the flow direction, consists of a noble metal wire which contains, besides impurities, only platinum and no further components.

In preferred embodiments, the catalyst system can comprise separating elements, for example in the form of intermediate networks. Such separating elements can be used to counteract compression and/or melting or sintering of adjacent catalyst networks or catalyst network groups under pressure loading. The separating element(s) preferably has/have limited flexibility compared to the catalyst networks.

Suitable separating elements are, for example, elements or networks made of a heat-resistant steel, typically a FeCrAl alloy such as Megapyr or Kanthal, of stainless steel, or of heat-resistant alloys, such as nickel-chromium alloys. The separating element(s) may also comprise a catalytically active coating comprising at least one noble metal.

The catalyst system according to the invention is particularly suitable for the preparation of nitric acid by the Ostwald process. An ammonia-oxygen mixture flows through the catalyst system for catalytic ammonia combustion.

The present invention also relates to a method for the catalytic oxidation of ammonia, in which a fresh gas containing ammonia is conducted via a catalyst system according to the invention. For preferred embodiments of the catalyst system, reference is made to the preceding statements.

The ammonia content of the fresh gas is preferably between 9 and 12% by volume.

The pressure of the fresh gas is preferably between 1 and 14 bar, in particular between 3 and 10 bar. The catalyst network temperature is preferably in the range from 600 to 1100° C., preferably in the range from 700 to 1000° C.

Preferably, the fresh gas is conducted via a catalyst system according to the present invention at a throughput in the range from 3 to 90 tN/m²d. The abbreviation “tN/m²d” stands for “tons of nitrogen (from ammonia) per day and per standardized effective cross-sectional area of the catalyst system of one square meter.

The invention is explained below with reference to drawings and an experiment on overall catalytic efficiency.

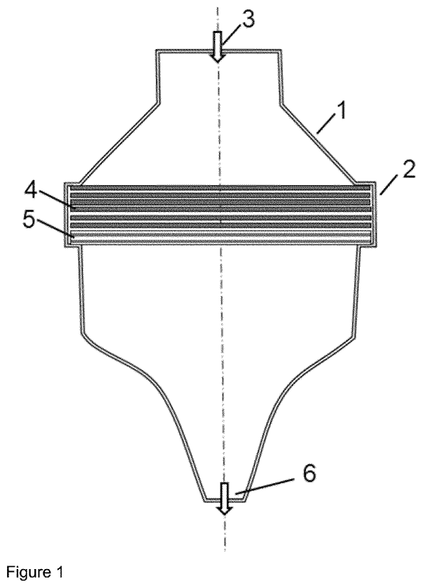

FIG. 1 schematically shows a vertically positioned flow reactor 1 for the heterogeneously catalytic oxidation of ammonia. The catalyst system 2 forms the actual reaction zone of the flow reactor 1. The catalyst system 2 comprises a plurality of catalyst networks 4 which are arranged one behind the other in the flow direction 3 of the fresh gas and behind which a plurality of catchment networks 5 can be arranged. The effective catalyst network diameter can be up to 6 m. The networks used are in each case textile fabrics produced by means of machine weaving or knitting of noble metal wires.

The fresh gas is an ammonia-air mixture that is heated to a preheating temperature and introduced from above into the reactor 1 at elevated pressure. Upon entry into the catalyst system 2, the gas mixture is ignited and a subsequent exothermic combustion reaction takes place. The following main reaction takes place:

4NH₃+5O₂→4NO+6H₂O

In this case, ammonia (NH₃) is converted to nitrogen monoxide (NO) and water (H₂O). The nitrogen monoxide (NO) formed reacts in the outflowing reaction gas mixture (symbolized by the directional arrow 6 indicating the flow direction of the outflowing reaction gas mixture) with excess oxygen to form nitrogen dioxide (NO₂), which is reacted with water in a downstream absorption system to form nitric acid (HNO₃).

In a test reactor according to FIG. 1, three catalyst systems were compared, each comprising five catalyst networks made of a binary PtRh alloy and additionally six catchment networks made of a PdNi5 alloy. The test reactor (IE) according to the invention contained PtRh4 networks, and the comparison reactors contained PtRh3 networks (CE1) or PtRh5 networks (CE2). The catalyst networks were produced by machine-knitting a noble metal wire having a diameter of 76 μm from the relevant alloy. The fabric structure was the same for all networks and related to a mass per unit area for PtRh5 of 600 g/m².

The test reactors were operated under the following identical test conditions in each case.

| | |
|---|---|
| Pressure: | 5 bar (absolute) |
| Throughput: | 12 t/m²d N (12 tons of nitrogen (from |
| | ammonia) per day and effective cross- |
| | sectional area of the catalyst packing |
| | in square meters) |
| NH₃ proportion: | 10.7% by volume in the fresh gas |
| Preheating temp.: | 175° C. (temperature of NH₃/air mixture), |
| | resulting in a network temperature of 890° C. |

The development of the average daily catalyst efficiency of the relevant catalyst system (NO yield in %) was determined until the efficiency fell below a predetermined threshold value of 94% or the catalyst packet became too unstable for further operation of the reactor.

Table 1 compares the average efficiency of the catalyst systems on the first operating day (d1), which shows a linear dependence on the Rh proportion of the relevant catalyst system. In addition, the table shows the determined maximum running times and the average efficiency of the test systems measured over this time.

TABLE 1

| | Efficiency on | Max. running | Average |
|---|---|---|---|
| | d1 [%] | time [d] | efficiency [%] |
| CE1 (PtRh3) | 94.5 | 330 | 95.3 |
| IE (PtRh4) | 95.1 | 335 | 95.7 |
| CE2 (PtRh5) | 95.5 | 285 | 95.7 |

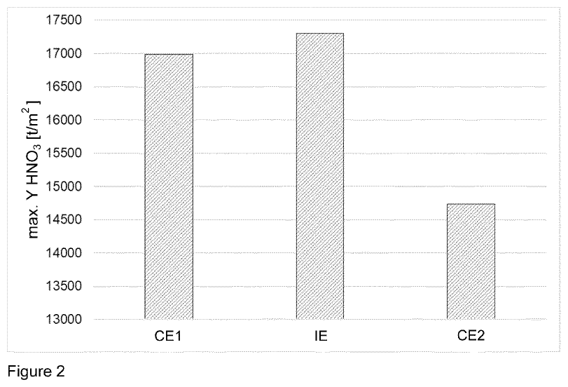

FIG. 2 compares the total yield of HNO₃ (max. Y) obtained over the relevant period, standardized to the area of the catalyst systems. Surprisingly, a maximum is observed here in the system according to the invention with an average Rh content (IE with PtRh4 as binary PtRh alloy) which is usually not used in industry.

With the reactor system according to the invention, an average efficiency was observed that increased by about 0.4% over the maximum achievable running time compared to the system with lower Rh content (CE1). In combination with a longer possible campaign duration, this average increase means a significant economic advantage. Compared to the system having a higher Rh content (CE2), the average efficiency was comparable. However, the system according to the invention likewise offers a significant economic improvement over the standard system due to the longer maximum running time, the increased total yield and the lower proportion of the price-determining rhodium.

1. A catalyst system for the catalytic oxidation of ammonia, comprising more than one catalyst network, wherein at least one of the catalyst networks contains at least one noble metal wire consisting of a binary PtRh alloy, wherein the binary PtRh alloy of the at least one noble metal wire consists of 3.4-4.6 wt. % of rhodium, impurities and the remainder platinum, and in that the catalyst system does not comprise a catalyst network containing a noble metal wire made of a further binary PtRh alloy comprising more than 7 wt. % of rhodium.

2. The catalyst system according to claim 1, wherein the catalyst networks are woven or knitted independently of one another.

3. The catalyst system according to claim 1, wherein the catalyst system comprises at least three catalyst networks containing a noble metal wire made of the binary PtRh alloy comprising 3.4-4.6 wt. % of rhodium.

4. The catalyst system according to claim 1, wherein the catalyst system comprises a plurality of catalyst network groups.

5. The catalyst system according to claim 1, wherein at least one of the catalyst networks comprises a three-dimensional structure.

6. The catalyst system according to claim 1, wherein the noble metal wires of the catalyst networks have a diameter of 40-150 pm.

7. The catalyst system according to claim 1, wherein the proportion of the impurities of the binary PtRh alloy is no more than 1 wt. %.

8. The catalyst system according to claim 1, wherein the binary PtRh alloy of the at least one noble metal wire consists of 3.6-4.4 wt. % of rhodium, impurities and the remainder platinum.

9. The catalyst system according to claim 1, wherein the catalyst system does not comprise a catalyst network containing a noble metal wire made of a further binary PtRh alloy comprising more than 6.5 wt. % of rhodium, preferably no more than 6 wt. % of rhodium.

10. The catalyst system according to claim 1, wherein the catalyst system does not comprise any further catalyst network containing a noble metal wire made of another binary PtRh alloy.

11. The catalyst system according to claim 1, wherein the catalyst system comprises at least one catalyst network containing a noble metal wire made of a palladium alloy.

12. The catalyst system according to claim 1, wherein the catalyst system comprises at least one separating element.

13. A method for the catalytic oxidation of ammonia in which a fresh gas containing ammonia is conducted via a catalyst system according to claim 1.
